(19) United States
(12) Patent Application Publication
(10) Pub. No.: US 2008/0301177 A1
(43) Pub. Date: Dec. 4, 2008

(54) SYSTEM AND METHOD FOR ORGANIZING CONCEPT-RELATED INFORMATION AVAILABLE ON-LINE

(76) Inventor: Donald W. Doherty, Pittsburgh, PA (US)

Correspondence Address: REED SMITH LLP, P.O. BOX 488, PITTSBURGH, PA, 15230-0488, US

(21) Appl. No.: 12/131,885

(22) Filed: Jun. 2, 2008

Related U.S. Application Data
(60) Provisional application No. 60/941,285, filed on May 31, 2007.

(51) Int. Cl. G06F 17/00

(52) U.S. Cl. 707/102

(57) ABSTRACT

A method, implemented at least in part by a computing device, for organizing concept-related information available on-line. The method includes crawling the Internet and visiting a plurality of websites, determining the information present at a given visited website, defining an index for the given website that points to data at the website, defining a Resource Description Framework (RDF) statement for the given website, storing the RDF in a knowledge base, transforming data which is not in a given standard format into the standard format, and storing the transformed data in a database.

### CROSS-REFERENCE TO RELATED APPLICATION

This application claims the benefit under 35 U.S.C. §119(e) of the earlier filing date of U.S. Patent Application No. 60/941,285 filed on May 31, 2007.

### BACKGROUND

This application discloses an invention which is related, generally and in various embodiments, to a system and method for organizing concept-related information available on-line. The organization allows for the subsequent generation of visual representations of concepts utilizing data available on-line, and for performing simulations utilizing data available on-line.

Billions of dollars are spent on research each year, and vast amounts of associated data are published on a continuous basis. For just biomedical research alone, tens of billions of dollars are spent each year. The pharmaceutical industry attempts to translate the sum of current biomedical knowledge into safe and effective therapeutic substances to treat debilitating and sometimes devastating diseases. One challenge the industry faces in overcoming this challenge is the bottleneck between the data and what the data say about a particular system. Although searches for particular information can be performed using various services (e.g., Google, Yahoo, etc.), the services are passive and do not leverage a user's knowledge in any effective or useful way.

Progress in the biomedical sciences depends to a great degree on the timely sharing of knowledge. As the amount of available information continues to expand, it becomes increasingly difficult for researchers to quickly find data which is relevant to the specific needs of the researchers, if they can even find relevant data at all. Additionally, as the data sets associated with many research endeavors have become increasingly complex, it has also become more and more difficult for specialists to read and critically analyze many of the data sets.

Researchers within the drug discovery and development industry are often unable to integrate all of these data into meaningful pictures of the specificity, potency, and safety of their drug candidates. For example, generating the meaningful picture or knowledge often depends on from across many if not all of the levels of inquiry in biomedical research. Knowledge about specificity generally requires data on a potential therapeutic substances site of action, which would likely include data on a chemical receptor and data on locations of the chemical receptor in the body and in cells. Knowledge about potency would include detailed chemical and mathematical data at the proteome, physiome, and perhaps genome levels. As the data associated with drug candidate safety is not currently integrated across all of the levels of inquiry, the researchers typically have difficulty finding and/or effectively analyzing relevant data.

### SUMMARY

In one general respect, this application discloses a system. According to various embodiments, the system is for organizing concept-related information available on-line and includes a search engine module, a transformation engine module, a dynamic code generator module, a knowledge base, and a database. The search engine module is configured for crawling the Internet and visiting a plurality of websites, determining the information present at a given visited website, defining an index for the given website that points to data at the website, and defining a Resource Description Framework (RDF) statement for the given website. The transformation engine module is communicably connected to the search engine module and is configured for changing raw data from the given visited website into a highly structured vocabulary encapsulating the data. The dynamic code generator module is communicably connected to the search engine module, and is configured for receiving data which includes dynamic data and/or combined static and dynamic data which is not in a standard format utilized by the system, and for generating source code based on the received data. The knowledge base is communicably connected to the search engine module. The database is communicably connected to the transformation engine module.

According to other embodiments, the system is for generating a visual representation of a concept utilizing data available on-line, and includes a search engine module, a transformation engine module, a dynamic code generator module, a knowledge base, a database, a knowledge base engine module, a client web browser support engine module, and a client virtual workspace engine module. The search engine module is configured for crawling the Internet and visiting a plurality of websites, determining the information present at a given visited website, defining an index for the given website that points to data at the website, and defining a Resource Description Framework (RDF) statement for the given website. The transformation engine module is communicably connected to the search engine module and is configured for changing raw data from the given visited website into a highly structured vocabulary encapsulating the data. The dynamic code generator module is communicably connected to the search engine module, and is configured for receiving data which includes dynamic data and/or combined static and dynamic data which is not in a standard format utilized by the system, and for generating source code based on the received data. The knowledge base is communicably connected to the search engine module. The database is communicably connected to the transformation engine module. The knowledge base engine module is communicably connected to the search engine module and the knowledge base, and is configured for querying the knowledge base, and for requesting information from the database and/or the Internet. The client web browser support engine module is communicably connected to the knowledge base engine module, and is configured for transforming the data coordinates into scalable vector graphics coordinates. The client virtual workspace engine module is communicably connected to the client web browser support engine module, and is configured for creating a client session.

According to yet other embodiments, the system is for performing a simulation utilizing data available on-line, and includes a search engine module, a transformation engine module, a dynamic code generator module, a knowledge base, a database, a knowledge base engine module, a client web browser support engine module, and a client virtual workspace engine module. The search engine module is configured for crawling the Internet and visiting a plurality of websites, determining the information present at a given visited website, defining an index for the given website that points to data at the website, and defining a Resource Description Framework (RDF) statement for the given website. The transformation engine module is communicably connected to the search engine module and is configured for changing raw data from the given visited website into a highly structured vocabulary encapsulating the data. The dynamic code generator module is communicably connected to the search engine module, and is configured for receiving data which includes dynamic data and/or combined static and dynamic data which is not in a standard format utilized by the system, and for generating source code based on the received data. The knowledge base is communicably connected to the search engine module. The database is communicably connected to the transformation engine module. The knowledge base engine module is communicably connected to the search engine module and the knowledge base, and is configured for querying the knowledge base, and for requesting information from the database and/or the Internet. The client virtual workspace engine module is communicably connected to the knowledge base engine module, and is configured for starting the simulation. The client web browser support engine module is communicably connected to the client virtual workspace engine module, and is configured for sending results of the simulation to a web browser of a user.

In another general respect, this application discloses a method, implemented at least in part by a computing device, for organizing concept-related information available on-line. The method includes crawling the Internet and visiting a plurality of websites, determining the information present at a given visited website, defining an index for the given website that points to data at the website, defining a Resource Description Framework (RDF) statement for the given website, storing the RDF in a knowledge base, transforming data which is not in a given standard format into the standard format, and storing the transformed data in a database.

In yet another general respect, this application discloses a method, implemented at least in part by a computing device, for generating a visual representation of a concept utilizing data available on-line. The method includes receiving a request from a user to access a system; creating a client session for the user, sending a concept search page to a web browser associated with the user, receiving a request from the user for a concept search, generating an ontology matrix of available information, transforming data coordinates associated with the ontology matrix into scalable vector graphic coordinates, and forwarding the transformed data.

In yet another general respect, this application discloses a method, implemented at least in part by a computing device, for performing a simulation utilizing data available on-line. The method includes receiving a request from a user to access a system; creating a client session for the user, sending a concept search page to a web browser associated with the user, receiving a request from the user for a concept search, generating an ontology matrix of available information, transforming data into code which when executed simulates the dynamic data, and periodically forwarding results of the simulation.

Aspects of the invention may be implemented by a computing device and/or a computer program stored on a computer-readable medium. The computer-readable medium may comprise a disk, a device, and/or a propagated signal.

### BRIEF DESCRIPTION OF THE DRAWINGS

Various embodiments of the invention are described herein in by way of example in conjunction with the following figures, wherein like reference characters designate the same or similar elements.

FIG. 1 illustrates a high-level representation of a system;

FIG. 2 illustrates various embodiments of the system of FIG. 1;

FIG. 3 illustrates other embodiments of the system of FIG. 1;

FIG. 4 illustrates yet other embodiments of the system of FIG. 1;

FIG. 5 illustrates various embodiments of a method for organizing concept-related information available on-line;

FIG. 6 illustrates various embodiments of a method for generating a visual representation of a concept utilizing data available on-line.

FIG. 7 illustrates an example of a visual representation of the concept “Amyloid beta-Peptide”; and

FIG. 8 illustrates various embodiments of a method for performing a simulation utilizing data available on-line.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein. Also, for purposes of simplicity, the systems and methods will be described in the context of the life sciences, the described systems and methods are also applicable across a wide variety of scientific areas of study.

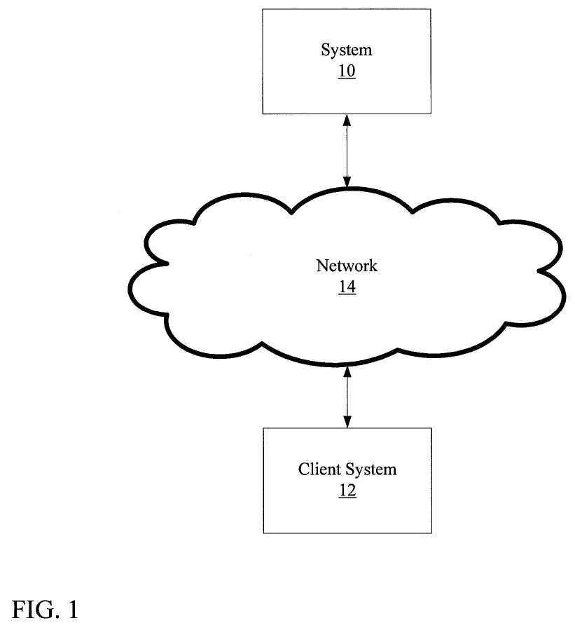

FIG. 1 illustrates a high-level representation of a system 10. The system 10 is based, at least in part, on the principles of the Semantic Web. Various embodiments of the system 10 may be utilized to organize concept-related information available on-line, to generate a visual representation of a concept utilizing data available on-line, and to perform a simulation utilizing data available on-line. As shown in FIG. 1, the system 10 is communicably connected to a client system 12 via a network 14.

The client system 12 is configured to present information to, and receive information from, a user. The client system 12 may include one or more client devices such as, for example, a workstation, a personal computer, a laptop computer, a network-enabled personal digital assistant, a network-enabled mobile telephone, etc. Other examples of a client device include, but are not limited to, a server, a microprocessor, an integrated circuit, fax machine or any other component, machine, tool, equipment, or some combination thereof capable of responding to and executing instructions and/or using data.

In general, the system 10 and the client system 12 each include hardware and/or software components for communicating with the network 14 and with each other. The system 10 and the client system 12 may be structured and arranged to communicate through the network 14 via wired and/or wireless pathways using various communication protocols (e.g., HTTP, TCP/IP, UDP, WAP, WiFi, Bluetooth) and/or to operate within or in concert with one or more other communications systems.

The network 14 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The network 14 may include elements, such as, for example, intermediate nodes, proxy servers, routers, switches, and adapters configured to direct and/or deliver data.

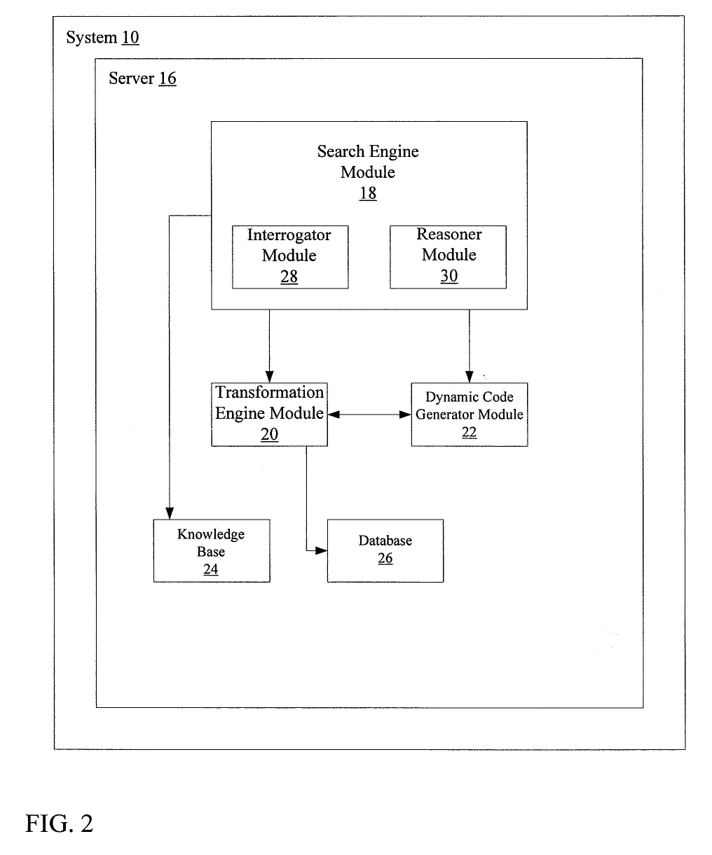

FIG. 2 illustrates various embodiments of the system 10 of FIG. 1. For these embodiments, the system 10 may be utilized to organize concept-related information available on-line. For these embodiments, the system 10 includes a server 16, a search engine module 18, a transformation engine module 20, a dynamic code generator module 22, a knowledge base 24, and a database 26.

The server 16 is in communication with the network 14 via a wired or wireless connection. The server 16 may be implemented by any suitable server. For example, the server 16 may be implemented by an IBM® OS/390 operating system server, a Linux operating system-based server, a Windows NT™ server, a Mac OS X server, etc. For purposes of simplicity, only one server 16 is shown in FIG. 1. However, the system 10 may include any number of servers, computing devices, and storage devices.

The search engine module 18 is configured to crawl the Internet and visit a plurality of websites, determine the information present at each website visited, define an index for each relevant website that points to data at the website, and define one or more Resource Description Framework (RDF) statements for each relevant website. Each RDF statement utilizes a subject-predicate-object expression known as a triple to categorize the content of a particular website. In general, the subject of a given RDF statement denotes a resource (e.g., a Uniform Resource Identifier (URI)), and the predicate denotes traits or aspects of the resource and expresses a relationship between the subject and the object. The indexes are stored at the server 16, and the RDF statements are stored at the knowledge base 24. According to various embodiments, the search engine module 18 resides at the server 16.

According to various embodiments, the search engine module 18 includes an interrogator module 28 and a reasoner module 30. The interrogator module 28 is configured for determining the type of data (e.g., static, dynamic, or a combination of static and dynamic) pointed to by a given index, including the attributes of the data. Static data are structures that do not change over time. Examples of such structures include chemical structures, cell structures, liver structures, etc. Dynamic data are data that change over time and are described by mathematics. The reasoner module 30 is configured for performing first order logical induction and deduction.

The transformation engine module 20 is communicably connected to the search engine 18, and is configured for changing raw data from a given website (which is in a particular format which is not the standard format utilized by the system 10) into highly structured vocabularies encapsulating the data (the standard format utilized by the system 10). The highly structured vocabularies encapsulating the data are stored at the database 26. According to various embodiments, the transformation module 18 resides at the server 16.

According to various embodiments, the transformation engine module 20 includes one or more sub-modules (e.g., a CellML transformation module, a NeuroML transformation module, etc.) which are configured for transforming raw data associated with particular concepts (e.g., cells, neurology, etc.) into highly structured vocabularies representative of those concepts.

The dynamic code generator module 22 is communicably connected to the search engine module 18 and to the transformation engine module 20. The dynamic code generator module 22 is configured to receive dynamic data and/or combined static and dynamic data which is not in the standard format utilized by the system 10, and to generate source code based on the received data. The source code is a representation of the received data, but is in standard format utilized by the system 10. The source code are stored at the database 26. According to various embodiments, the dynamic code generator module 22 resides at the server 16.

According to various embodiments, the dynamic code generator module 22 includes one or more sub-modules (e.g., a CellML code generator, a NeuroML code generator) which are configured for receiving non-standard format data associated with particular concepts (e.g., cells, neurology, etc.) and generating source code (i.e., standard format data) for those concepts.

The knowledge base 24 is communicably connected to the search engine module 18, and is configured for storing RDF statements associated with various websites. The database 26 is communicably connected to the transformation module 20, and is configured for storing data in a standard format utilized by the system 10.

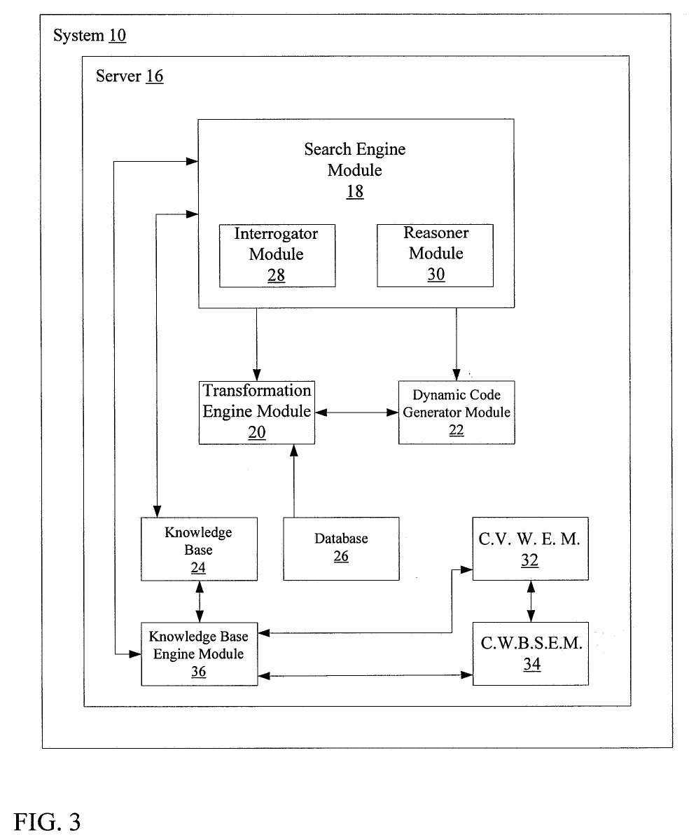

FIG. 3 illustrates other embodiments of the system 10 of FIG. 1. For these embodiments, the system 10 may be utilized to generate a visual representation of a concept utilizing data available on-line, and to facilitate the application of knowledge arising from data aggregated through on-line searches and related to the concept. For these embodiments, in addition to including the components of the system 10 of FIG. 2 (the server 16, the search engine module 18, the transformation engine module 20, the dynamic code generator module 22, the knowledge base 24, the database 26, the interrogator module 28, the reasoner module 30, and the respective sub-modules), the system 10 also includes a client virtual workspace engine module 32, a client web browser support engine module 34, and a knowledge base engine module 36.

For these embodiments, the search engine module 18 and the knowledge base 24 are each communicably connected to the knowledge base engine module 36, and the search engine module 18 is also configured for pulling information from the knowledge base 24 and/or the Internet, as well as for pulling information from the database 26.

The client virtual workspace engine module 32 is communicably connected to the server 16, and is configured for creating a client session when a device of the client system 14 requests access to the system 10. According to various embodiments, the client virtual workspace engine module 32 resides at the server 16.

The client web browser support engine module 34 is communicably connected to the client virtual workspace engine module 32, and is configured for sending concept search pages to devices of the client system 12. The client web browser support engine module 34 is also communicably connected to the knowledge base engine module 36, and is also configured for dynamically filtering a cached list of concepts stored at the knowledge base 24 against text entered into the concept search page (at a device of the client system 12). The client web browser support engine module 34 is further configured for sending visual representations of concepts to devices of the client system 12. According to various embodiments, the client web browser support engine module 34 resides at the server 16.

According to various embodiments, the client web browser support engine module 34 includes one or more sub-modules (e.g., an organism viewer module) which are configured for displaying chemicals, genes, proteins, morphology, and anatomy using scalable vector graphics in Web browsers.

The knowledge base engine module 36 is communicably connected to the search engine module 18, the knowledge base 24, the client virtual workspace engine module 32, and the client web browser support engine module 34. The knowledge base engine module 36 is configured for querying the knowledge base 24, for requesting information from the database 26 and/or the Internet via the search engine module 18, and for sending the requested information to the client web browser support engine module 34. According to various embodiments, the knowledge base engine module 36 resides at the server 16.

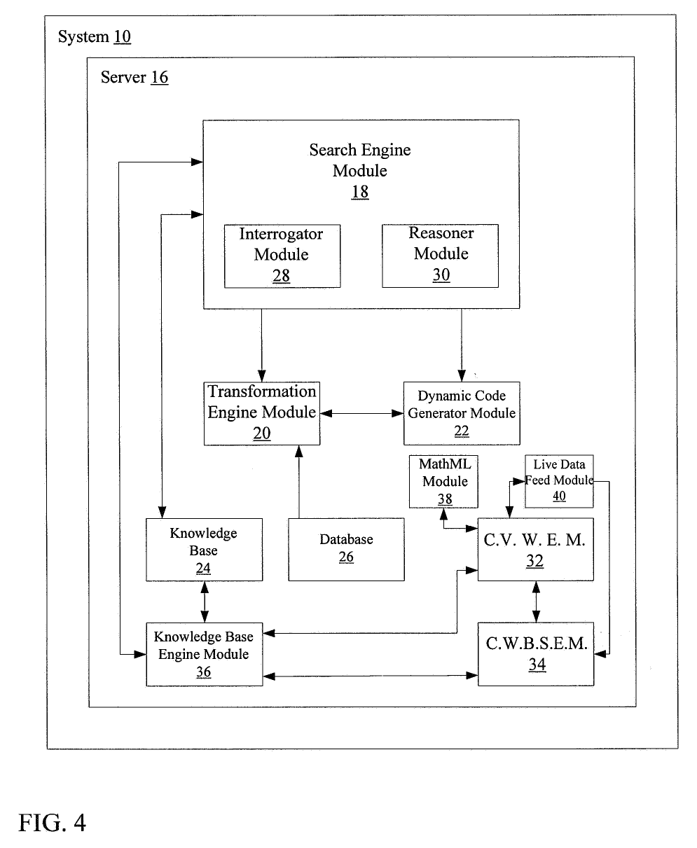

FIG. 4 illustrates yet other embodiments of the system 10 of FIG. 1. For these embodiments, the system 10 may be utilized to perform a simulation of data representative of a searched concept. For these embodiments, the system 10 includes each of the components of the system 10 of FIG. 3 (the server 16, the search engine module 18, the transformation engine module 20, the dynamic code generator module 22, the knowledge base 24, the database 26, the interrogator module 28, the reasoner module 30, the client virtual workspace engine module 32, the client web browser support engine module 34, the knowledge base engine module 36, and the respective sub-modules). For the embodiments of FIG. 4, the client workspace engine module 32 is further configured to run simulations of the data representative of a searched concept. Additionally, the client browser support engine module 34 further includes at least one additional sub-module, an oscilloscope viewer module, which is configured for the scalable vector graphics display in Web Browsers of time dependent data variables.

For these embodiments, the system 10 also includes a MathML module 38 and a live data feed module 40. The MathML module 38 is communicably connected to the client virtual workspace engine module 32, and is configured for updating numerical computations included in the structured data stored in the database 26. The live feed data module 40 is communicably connected to the client virtual workspace engine module 32 and the client web browser support engine module 34, and is configured to periodically receive information from the simulation and forward the information to the client web browser support engine module 34.

For the embodiments of FIGS. 2-4, the modules 18, 20, 22, 28, 30, 32, 34, 36, 38 and 40, as well as the respective sub-modules, may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 18, 20, 22, 28, 30, 32, 34, 36, 38 and 40, as well as the respective sub-modules, (e.g., software application, computer program) may be stored on a computer-readable medium (e.g., disk, device, and/or propagated signal) such that when a computer reads the medium, the functions described herein are performed.

According to various embodiments, the modules 18, 20, 22, 28, 30, 32, 34, 36, 38 and 40, as well as the respective sub-modules, may reside at the server 16, other devices within the system 10, or combinations thereof. For embodiments where the system 10 includes more than one server 16, the modules 18, 20, 22, 28, 30, 32, 34, 36, 38 and 40, as well as the respective sub-modules, may be distributed across a plurality of servers 16. According to various embodiments, the functionality of the modules 18, 20, 22, 28, 30, 32, 34, 36, 38 and 40, as well as the respective sub-modules, may be combined into fewer modules (e.g., a single module).

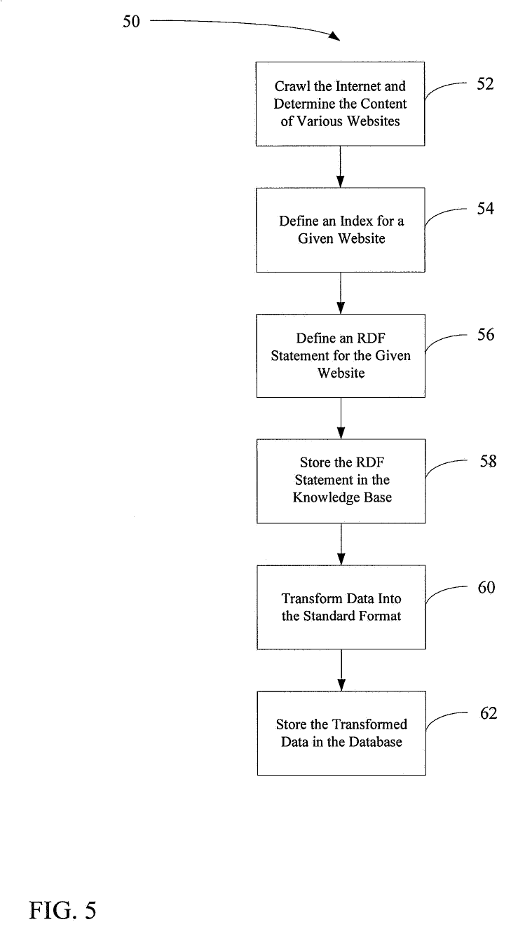

FIG. 5 illustrates various embodiments of a method 50 for organizing concept-related information available on-line. The method 50 may be implemented by the system 10 of FIG. 2. For purposes of simplicity, the method 50 will be described in conjunction with the system 10 of FIG. 2.

The process starts at block 52, where the search engine module 18 crawls the world-wide-web visiting a plurality of websites and determining the content of the visited websites. From block 52, the process advances to block 54, where the search engine module 18 generates indexes which point to the respective content (i.e., data). Each index may be in the form of a Uniform Resource Identifier (URI) which points to a unit of data at a given website.

From block 54, the process advances to block 56, where the search engine module 18 generates one or more RDF statements associated with the URI. According to various embodiments, each URI is encapsulated as a resource (i.e., as an element in an RDF statement). From block 56, the process advances to block 58, where the RDF statement is stored in the knowledge base 24.

From block 58, the process advances to block 60, where the transformation engine 20 transforms data which is not in a given standard format (i.e., unstructured data) into the standard format (i.e., structured data). From block 60, the process advances to block 62, where the structured data is stored in the database 26. The process from block 52 to block 60 may be repeated any number of times, and some of the visited websites may be revisited any number of times.

According to various embodiments, the method 50 may include additional steps and/or intermediate steps. Listed below is a simplified outline of the process flow of the method 50 according to some of such embodiments.

1) The search engine module 18 continuously crawls the Internet initially to set up and then to maintain updated indexes to data in select databases and sites. An index is a Uniform Resource Identifier (URI) that points to a unit of data on the Internet.

2) If the index is new:
a) the interrogator module 28 determines the type of data pointed to by a URI.
b) the URI is encapsulated as a resource in the knowledge base 24. A resource is an element in the Resource Description Framework (RDF).
c) an RDF statement defining the resource's data type is added to the knowledge base 24.
d) other RDF statements including the resource are added to the knowledge base 24 reflecting the resource's data attributes discovered by the interrogator module 28.

3) Else if the index already exists:
a) the interrogator module 28 confirms the type of data pointed to by a URI.
b) if the data type equals the type expected (i.e. the same data type as indicated in the resource's RDF statement in the knowledge base 24), make no changes.
c) else if the data type does not equal the type expected, update the resource's RDF statement defining its type of data in the knowledge base 24 by replacing the old data type with the new data type.
d) the interrogator module 28 confirms that the existing RDF statements for the resource reflect the resource's existing data attributes.
e) if the RDF statement is true for existing data pointed to by the resource's URI, make no changes to the statement.
f) else if the RDF statement is false for existing data pointed to by the resource's URI, remove the RDF statement from the knowledge base.
g) the interrogator module 28 looks for data attributes not reflected in the resource's RDF statements in the knowledge base 24.
h) if a new data attribute is found that is not reflected in the resource's RDF statements in the knowledge base 24, add an RDF statement including the resource that reflects the resource's newly discovered data attribute.
i) if no new data attributes are found, make no changes to the knowledge base 24.

4) the interrogator module 28 determines if a new resource includes static (time independent) or dynamic (time dependent) data or a combination of static and dynamic data.

5) static data are passed to the transformation engine module 20 and then to the transformation component appropriate to the data type (e.g., a CellML transformation module).

6) if the data are natively (from its source) in the structured data form set as the standard by the system 10, take no further action. The resource's URI in the knowledge base 24 remains the same as the initial index and the data are fetched from that source on demand.

7) else if the data are unstructured or are in a structured data form not standard to the system 10:
a) transform the data into the standard structured data form for the system 10.
b) persist the data to the database 26.
c) give the resource a URI to the database 26 that takes priority over its URI to the original data source.

8) dynamic data are passed to the dynamic code generator module 22.

9) if mathematics are not in the standard structured data form (e.g., MathML) for the system 10:
a) transform the mathematics into MathML.
b) persist the data (mathematics in the form of MathML) to the database 26.
c) give the resource a URI to the database 26 that takes priority over its URI to the original data source.

10) else if the mathematics are in MathML, take no further action. The resource's URI in the knowledge base 24 remains the same as the initial index and the data are fetched from that source on demand.

11) combined static and dynamic data are passed to the transformation engine module 20 and then to the transformation component appropriate to the static data type.

12) if the static data are natively (from its source) in the structured data form set as the standard by the system 10:
a) pass the resulting data structure to the dynamic code generator module 22.
b) if the embedded mathematics are not in the standard structured data form (e.g., MathML) for the system 10:
   i) transform the mathematics into MathML.
   ii) persist the entire combined static and dynamic data structure to the database 26.
   iii) give the resource a URI to the database 26 that takes priority over its URI to the original data source.
c) else if the mathematics are in MathML, take no further action. The resource's URI in the knowledge base 24 remains the same as the initial index and the data are fetched from that source on demand.

13) else if the data are unstructured or are in a structured data form not standard to the system 10:
a) transform the static data into the standard structured data form for the system 10 while maintaining the dynamic data embedded in the appropriate location within the static data structure.
b) pass the resulting data structure to the dynamic code generator module 22.
c) if the embedded mathematics are not in the standard structured data form (e.g., MathML) for the system 10:
   i) transform the mathematics into MathML.
   ii) persist the entire combined static and dynamic data structure to the database 26.
   iii) give the resource a URI to the database 26 that takes priority over its URI to the original data source.
d) else if the mathematics are in MathML:
   i) persist the entire combined static and dynamic data structure to the database 26.
   ii) give the resource a URI to the database 26 that takes priority over its URI to the original data source.

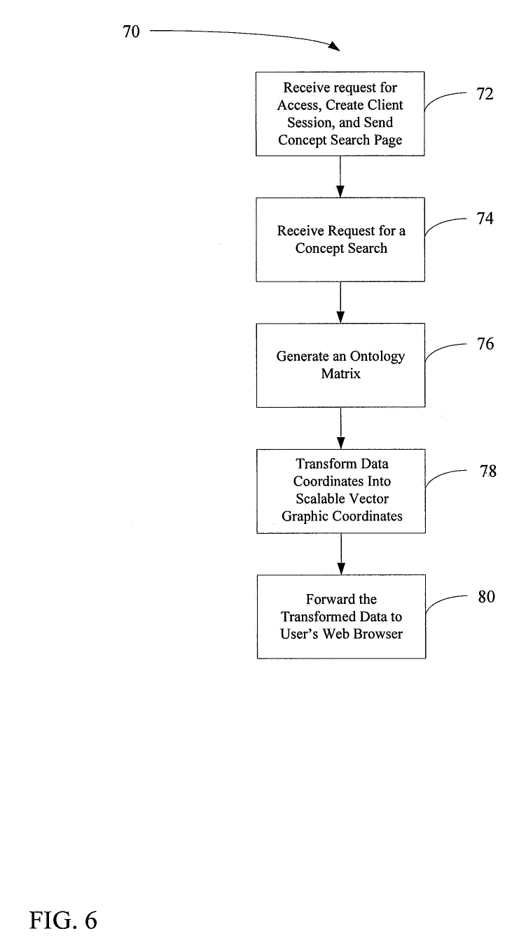

FIG. 6 illustrates various embodiments of a method 70 for generating a visual representation of a concept utilizing data available on-line. The method 70 may be implemented by the system 10 of FIG. 3. For purposes of simplicity, the method 70 will be described in conjunction with the system 10 of FIG. 3.

The process starts at block 72, where the system 10 receives a request from a device of a user of the client system 12 to access the system 10. Responsive to the request, the system 10 validates the user, the client virtual workspace engine module 32 creates a client session for the user, and the client web browser support engine module 34 sends a concept search page to the user's web browser.

From block 72, the process advances to block 74, where the system 10 receives a request for a concept search from the user. The request may be, for example, a request for a concept search of Amyloid beta-Protein. The system 10 may receive additional requests from the user which serve to narrow the focus of the concept search. For example, the request may be narrowed to target Amyloid beta-Protein aggregation.

From block 74, the process advances to block 76, where, responsive to the request, the knowledge base engine module 36 generates an ontology matrix (e.g., a matrix which indicates the location of available information). For a given piece of information, the information may be located at the database 26 or at a particular website.

From block 76, the process advances to block 78, where the requested information is gathered and transformed into a visual representation of the concept. For static data (e.g., chemical structures, cell structures, liver structures, etc.), the data are coordinates that the system 10 is able to transform into a scalable vector graphics image by simply transforming the coordinate data into an appropriate scalable vector graphic coordinate system.

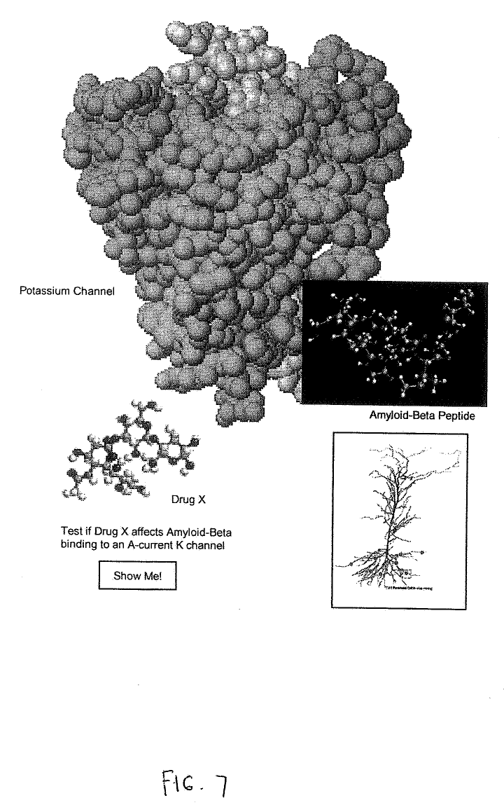

From block 78, the process advances to block 80, where the client web browser support engine module 34 sends the transformed data to the user's Web browser for viewing by the user. FIG. 7 illustrates an example of a visual representation of the concept “Amyloid beta-Protein”. The process from block 72 to block 80 may be repeated any number of times. As described hereinafter, the method 70 may include additional steps and/or intermediate steps.

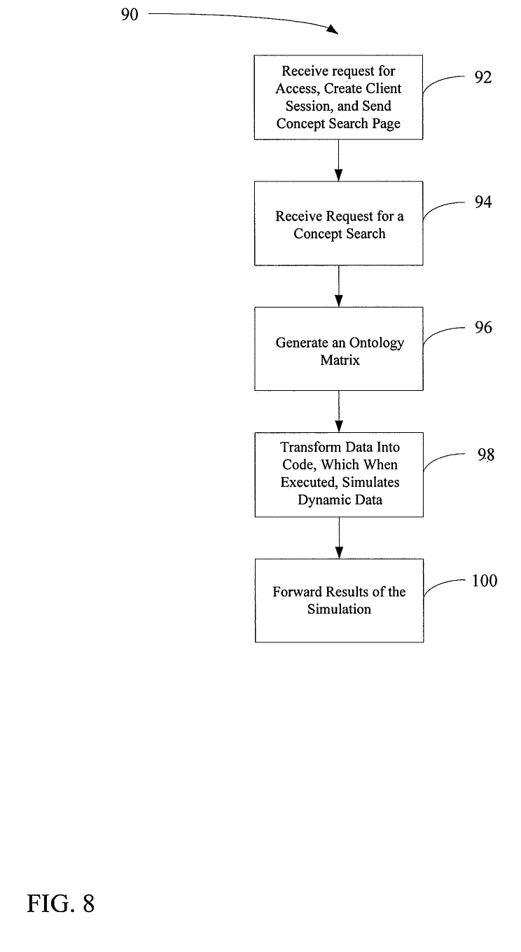

FIG. 8 illustrates various embodiments of a method 90 for performing a simulation utilizing data available on-line. The method 90 may be implemented by the system 10 of FIG. 4. For purposes of simplicity, the method 90 will be described in conjunction with the system 10 of FIG. 4.

The process starts at block 92, where the system 10 receives a request from a device of a user of the client system 12 to access the system 10. Responsive to the request, the system 10 validates the user, the client virtual workspace engine module 32 creates a client session for the user, and the client web browser support engine module 34 sends a concept search page to the user's web browser.

From block 92, the process advances to block 94, where the system 10 receives a request for a concept search from the user. The request may be, for example, a request for a concept search of Amyloid beta-Protein. The system 10 may receive additional requests from the user which serve to narrow the focus of the concept search. For example, the request may be narrowed to target Amyloid beta-Protein aggregation.

From block 94, the process advances to block 96, where, responsive to the request, the knowledge base engine module 36 generates an ontology matrix (e.g., a matrix which indicates the location of the collective information requested). For a given piece of information which includes dynamic data, the information is located at the database 26.

From block 96, the process advances to block 98, where the information is received by the client virtual workspace engine module 32 and the client virtual workspace engine module 32 performs a simulation utilizing the dynamic data. For dynamic data (e.g., described by mathematics), the mathematics are transformed into an appropriate structure (e.g., MathML) and placed in the context of static data (e.g., a liver cell), and transformed into code (e.g., Java code) that, when executed, simulates the dynamic data. For example, if the liver operates to break down alcohol into water, glucose, etc., then the process that does the breaking down is described mathematically. The mathematics are placed in the context of a liver cell. All of this is transformed into Java code that when executed simulates the liver cell changing alcohol into water, glucose, etc.

From block 98, the process advances to block 100, where the results of the simulation are periodically forwarded to the client web browser support engine module 34 for subsequent forwarding to the user's Web browser for viewing by the user. The process from block 92 to block 100 may be repeated any number of times.

According to various embodiments, the method 70 and the method 90 may each include additional steps and/or intermediate steps. Listed below is a simplified outline of the process flow which includes the method 70 and the method 90 according to some of such embodiments. The simplified outline also includes actions taken by a user of the client system 12 via a graphical user interface at the user's device.

1) a bench research scientist (a “user”) at a drug discovery and development company wishes to know the state of the knowledge about Amyloid beta-Protein and, in particular, how the protein may aggregate amongst the cells in the brain.

2) the user starts the Web browser on their computer.

3) the user types in the URL associated with the system 10.
a) a client session is created for the user by the client virtual workspaces engine module 32.
b) the client virtual workspaces engine module 32 notifies the client web browser support engine module 34 that a new client session has been created.
c) the client web browser support engine module 34 sends the initial concept search page to the user's Web browser.

4) the concept search page displaying the Search tab appears at the user's device.

5) the user types “Amyloid” in the concept search text box.
a) the client web browser support engine module 34 is dynamically notified of each change in text in the concept search box through JavaServer Faces (JSF) Ajax mechanisms.
b) the client web browser support engine module 34 dynamically filters a cached list of concepts from the knowledge base 24 against the text typed in by the user.
c) The filtered list of concepts is sent by the client web browser support engine module 34 through JSF Ajax mechanisms to a drop-down list in the user's Web browser. In this case, all concepts that include “Amyloid” are listed such as “Amyloid”, “Serum Amyloid P-Component”, “Amyloid beta-Protein”, “Amyloidosis, Familial”, etc.

6) a drop-down list appears that includes the concept “Amyloid beta-Protein.”

7) the user selects “Amyloid beta-Protein” from the drop-down list.
a) the client web browser support engine module 34 is notified of the concept selected.
b) the client web browser support engine module 34 pulls the concept's associated Descriptor Identifier. A Descriptor Identifier is the internal identifier associated with each concept in the knowledge base 24.

8) the user leaves the Visualize/Simulate check box selected (may be selected by default for subscribers to visualization and simulation services).
a) the Visualize/Simulate Amyloid beta-Protein tab property in the client web browser support engine module 34 is set to true.

9) the user clicks on the Concept Search button.
a) the client web browser support engine module 34 makes a request to the knowledge base engine module 36 to produce an Ontology Matrix.
   i) the knowledge base engine module 36 queries the knowledge base 24 for matches between the Descriptor Identifier and a set of Qualifiers in the RDF graph. Qualifiers may include, for example, genes, proteins, physiology, anatomy, disease, psychology, etc. A match indicates that the system 10 has access to knowledge and data for the particular concept identified by the Descriptor Identifier at the level of description (abstraction) defined by the particular Qualifier.
   ii) a list of the Qualifiers valid for the particular Descriptor Identifier is produced.
   iii) the knowledge base engine module 36 decides the level of description (Qualifier) about the data, in this case Amyloid beta Protein, that'll be displayed and simulated by default.
      a) the default Qualifier is known as the Prime Qualifier.
      b) the Prime Qualifier is selected from the Qualifier list based on the typical level of description for the particular concept defined by the Descriptor Identifier.
      c) in this example, Amyloid beta-Protein is a protein so the Protein Qualifier is selected as the Prime Qualifier.
   iv) the knowledge base engine module 36 queries the knowledge base 24 for the its knowledge (actually an RDF graph) that matches the intersection of the Descriptor Identifier and Prime Qualifier.
   v) an RDF graph is returned containing resources about Amyloid beta-Protein at the protein level (named here the Amyloid beta-Protein RDF Graph).
   vi) the knowledge base engine module 36 queries the Amyloid beta-Protein RDF Graph for static data resources.
   vii) the result is an Amyloid beta-Protein Static Data RDF Graph.
   ix) if the Amyloid beta-Protein Static Data RDF Graph defines no static data resources, take no action.
   x) else if the Amyloid beta-Protein Static Data RDF Graph defines one static data resource:
      a) set the static data resource as the Prime Static Data Resource.
      b) the knowledge base engine module 36 makes a request to the search engine module 18 to pull the structured data defined in the Prime Static Data Resource from their repositories (from the Internet or the database 26).
      c) the knowledge base engine module 36 sends the structured data to the client web browser support engine module 34 to be displayed in an Organism Viewer component in the user's Web browser.
   xi) else if the Amyloid beta-Protein Static Data RDF Graph defines more than one static data resources:
      a) the knowledge base engine module 36 queries the Amyloid beta-Protein Static Data RDF Graph for static data resources with a citation index number. A citation index number is based on the number of time the data's associated research paper(s) were cited.
      b) If no static data resources have a citation index number:
         1) the knowledge base engine queries the Amyloid beta-Protein Static Data RDF Graph for static data resources previously viewed in the system 10.
         2) if no static data resources have been previously viewed in the system, randomly set one static data resource as the Prime Static Data Resource.
         3) else if one static data resource has been previously viewed in the system 10, set the static data resource as the Prime Static Data Resource.
         4) else if more than one static data resource has been previously viewed in the system 10:
         a) if more than one static data resource has been viewed the most (the same highest number of times viewed), randomly set one of the static data resources viewed the most as the Prime Static Data Resource.
         b) else, set the static data resource viewed the most as the Prime Static Data Resource.
         c) else if one static data resource has a citation index number, set the static data resource as the Prime Static Data Resource.
         d) else if more than one static data resource has a citation index number:
         1) if more than one static data resource has the same and highest citation index number, randomly set one of the static data resources with the same and highest citation index as the Prime Static Data Resource.
         2) else, set the static data resource with the highest citation index number as the Prime Static Data Resource.
         e) the knowledge base engine module 36 makes a request to the search engine module 18 to pull the structured data defined in the Prime Static Data Resource from their repositories (from the Internet or the database 26).
         f) the knowledge base engine module 36 sends the structured data to the client web browser support engine module 34 to be displayed in an Organism Viewer component in the user's Web browser.
         g) the knowledge base engine module 36 sends the list of static data resources to the client web browser support engine module 34 to be displayed in a Drop-Down List component associated with the Organism Viewer. The Prime Static Data Resource is selected by default.
   xii) the knowledge base engine module 36 queries the Amyloid beta-Protein RDF Graph for combined static and dynamic data resources.
   xiii) the result is an Amyloid beta-Protein Combined Data RDF Graph.
   xiv) if the Amyloid beta-Protein Combined Data RDF Graph defines no combined data resources, take no action.
   xv) else if the Amyloid beta-Protein Combined Data RDF Graph defines one combined data resource:
      a) set the combined data resource as the Prime Combined Data Resource.
      b) the knowledge base engine module 36 makes a request to the search engine module 18 to pull the structured data defined in the Prime Combined Data Resource from their repositories (from the Internet or the database 26).
      c) the knowledge base engine module 36 sends the structured data to the client web browser support engine module 34 to be displayed in an Organism Viewer component in the user's Web browser.
      d) the knowledge base engine module 36 makes a request to the search engine module 18 to pull the Java code defined in the Prime Combined Data Resource from the database 26.
      e) the knowledge base engine module 36 sends the Java code to the client virtual workspaces engine module 32 to be set in the user's workspace.
      f) the knowledge base engine module 36 sends the client web browser support engine module 34 a reference to the Environment class for the Prime Combined Data Resource's dynamic data simulation and identifies the type of viewer component that the client web browser support engine module 34 must provide (for instance, an Oscilloscope Viewer).
      g) the knowledge base engine module 36 notifies the client virtual workspaces engine module 32 to start the simulation.
      h) each time step the simulation sends MathML to the Math ML module 38 for updating numerical computations.
      i) on a periodic basis the client virtual workspaces engine module 32 sends results of the simulation to the live data feed module 40 for communication to the client web browser support engine module 34.
   xvi) else if the Amyloid beta-Protein Combined Data RDF Graph defines more than one combined data resources:
      a) the knowledge base engine module 36 queries the Amyloid beta-Protein Combined Data RDF Graph for combined data resources with a citation index number. A citation index number is based on the number of time the data's associated research paper(s) were cited.
      b) if no combined data resources have a citation index number:
         1) the knowledge base engine module 36 queries the Amyloid beta-Protein Combined Data RDF Graph for combined data resources previously viewed in the system 10.
         2) if no combined data resources have been previously viewed in the system 10, randomly set one combined data resource as the Prime Static Data Resource.
         3) else if one combined data resource has been previously viewed in the system 10, set the combined data resource as the Prime Combined Data Resource.
         4) else if more than one combined data resource has been previously viewed in the system 10:
         a) if more than one combined data resource has been viewed the most (the same highest number of times viewed), randomly set one of the combined data resources viewed the most as the Prime Combined Data Resource.
         b) else, set the combined data resource viewed the most as the Prime Combined Data Resource.
         c) else if one combined data resource has a citation index number, set the combined data resource as the Prime Combined Data Resource.
         d) else if more than one combined data resource has a citation index number:
         1) if more than one combined data resource has the same and highest citation index number, randomly set one of the combined data resources with the same and highest citation index as the Prime Combined Data Resource.
         2) else, set the combined data resource with the highest citation index number as the Prime Combined Data Resource.
         e) the knowledge base engine module 36 makes a request to the search engine module 18 to pull the structured data defined in the Prime Combined Data Resource from their repositories (from the Internet or the database 26).
         f) the knowledge base engine module 36 sends the structured data to the client web browser support engine module 34 to be displayed in an Organism Viewer component in the user's Web browser.
         g) the knowledge base engine module 36 makes a request to the search engine module 18 to pull the Java code defined in the Prime Combined Data Resource from the database 26.
         h) the knowledge base engine module 36 sends the Java code to the client virtual workspaces engine module 32 to be set in the user's workspace.
         i) the knowledge base engine module 36 sends the client web browser support engine module 34 a reference to the Environment class for the Prime Combined Data Resource's dynamic data simulation and identifies the type of viewer component that the engine must provide (for instance, an Oscilloscope Viewer).
         j) the knowledge base engine module 36 notifies the client virtual workspaces engine module 32 to start the simulation.
         k) each time step the simulation sends MathML to the MathML module 38 for updating numerical computations.
         l) on a periodic basis the client virtual workspaces engine module 32 sends the results of the simulation to the live data feed module 40 for communication to the client web browser support engine module 34.
         m) the knowledge base engine module 36 sends the list of combined data resources to the client web browser support engine module 34 to be displayed in a Drop-Down List component associated with a combined data window. The Prime Combined Data Resource is selected by default.

10) the client web browser support engine displays a tab labeled with “Visualize/Simulate” postfixed with the concept being visualized and simulated (in this example the “Visualize/Simulate Amyloid beta-Protein” tab). Scalable vector graphics are employed to display the tab.

11) high-level statistics about the results of the concept search are also displayed such as the number of papers found, the species that turned up, the number of genes found for each species, the number of proteins found for each species, and the number of cellular processes found.

12) the user may click on a statistic or data item for details. For example, when the user clicks on the number of papers found the Papers tab opens and displays the papers found for the concept of Amyloid beta-Protein.

13) the Visualize/Simulate tab displays a concept search text box to enable further concept refinement within the concept tab's domain.

14) the user enters “aggregation” into the Visualize/Simulate Amyloid beta-Protein tab's concept text box and clicks the Concept Search button.

15) the results of the Amyloid beta-Protein concept search are whittled down to only those that also include the concept of aggregation.

16) the tab label is updated to “Visualize/Simulate Amyloid beta-Protein aggregation.”

17) the high-level statistics are updated to show the new results focused on Amyloid beta-Protein aggregation.

18) a list of available simulation alternatives is displayed. These alternatives may include different interpretations from competing laboratories, various simulation environments that may lead to different outcomes, etc.

19) if some of the simulation alternatives have associated citation indexes based on the number of times the research paper(s) were cited, run and display the simulation and visualization with the highest citation index.

20) else if some of the simulation alternatives have previously been viewed on the system 10:
a) run and display the simulation and visualization that has been viewed the most.
b) else, randomly run and display one of the simulation and visualization alternatives.

In view of the foregoing, one will appreciate how the described systems and/or methods may be utilized to rapidly assess the state of the knowledge within a particular conceptual domain and test possible scenarios against the state of the knowledge through simulations.

Although the invention has been described in terms of particular embodiments in this application, one of ordinary skill in the art, in light of the teachings herein, can generate additional embodiments and modifications without departing from the spirit of, or exceeding the scope of, the claimed invention. For example, some steps of the described methods may be performed concurrently or in a different order. Accordingly, it is understood that the drawings and the descriptions herein are proffered only to facilitate comprehension of the invention and should not be construed to limit the scope thereof.

What is claimed is:

1. A system for organizing concept-related information available on-line, the system comprising:
a search engine module configured for:
crawling the Internet and visiting a plurality of websites;
determining the information present at a given visited website;
defining an index for the given website that points to data at the website; and
defining a Resource Description Framework (RDF) statement for the given website;
a transformation engine module communicably connected to the search engine module, wherein the transformation engine module is configured for changing raw data from the visited website into a highly structured vocabulary encapsulating the data;
a dynamic code generator module communicably connected to the search engine module, wherein the dynamic code generator module is configured for:
receiving data which includes at least one of the following:
dynamic data which is not in a standard format utilized by the system; and
combined static and dynamic data which is not in a standard format utilized by the system; and
generating source code based on the received data;
a knowledge base communicably connected to the search engine module; and
a database communicably connected to the transformation engine module.

2. A system for generating a visual representation of a concept utilizing data available on-line, the system comprising:
a search engine module configured for:
crawling the Internet and visiting a plurality of websites;
determining the information present at a given visited website;
defining an index for the given website that points to data at the website; and
defining a Resource Description Framework (RDF) statement for the given website;
a transformation engine module communicably connected to the search engine module, wherein the transformation engine module is configured for changing raw data from the visited website into a highly structured vocabulary encapsulating the data;
a dynamic code generator module communicably connected to the search engine module, wherein the dynamic code generator module is configured for:
receiving data which includes at least one of the following:
dynamic data which is not in a standard format utilized by the system; and
combined static and dynamic data which is not in a standard format utilized by the system; and
generating source code based on the received data;
a knowledge base communicably connected to the search engine module;
a database communicably connected to the transformation engine module;
a knowledgebase engine module communicably connected to the search engine module and the knowledge base, wherein the knowledge base engine module is configured for:
querying the knowledge base; and
requesting information from at least one of the following:
the database; and
the Internet;
a client web browser support engine module communicably connected to the knowledge base engine module, wherein the client web browser support module is configured for transforming data coordinates into scalable vector graphics coordinates; and
a client virtual workspace engine module communicably connected to the client web browser support engine module, wherein the client virtual workspace engine is configured for creating a client session.

3. A system for performing a simulation utilizing data available on-line, the system comprising:
a search engine module configured for:
crawling the Internet and visiting a plurality of websites;
determining the information present at a given visited website;
defining an index for the given website that points to data at the website; and
defining a Resource Description Framework (RDF) statement for the given website;
a transformation engine module communicably connected to the search engine module, wherein the transformation engine module is configured for changing raw data from the visited website into a highly structured vocabulary encapsulating the data;
a dynamic code generator module communicably connected to the search engine module, wherein the dynamic code generator module is configured for:
receiving data which includes at least one of the following:
dynamic data which is not in a standard format utilized by the system; and
combined static and dynamic data which is not in a standard format utilized by the system; and
generating source code based on the received data;
a knowledge base communicably connected to the search engine module;
a database communicably connected to the transformation engine module;
a knowledgebase engine module communicably connected to the search engine module and the knowledge base, wherein the knowledge base engine module is configured for:
querying the knowledge base; and
requesting information from at least one of the following:
the database; and
the Internet;
a client virtual workspace engine module communicably connected to the knowledge base engine module, wherein the client virtual workspace engine is configured for starting the simulation; and
a client web browser support engine module communicably connected to the knowledge base engine module, wherein the client web browser support module is configured for sending results of the simulation to a web browser of a user.

4. A method, implemented at least in part by a computing device, for organizing concept-related information available on-line, the method comprising:
crawling the Internet and visiting a plurality of websites;
determining information present at a given visited website;
defining an index for the given website that points to data at the website;
defining a Resource Description Framework (RDF) statement for the given website;
storing the RDF in a knowledge base;
transforming data which is not in a given standard format into the standard format; and
storing the transformed data in a database.

5. A method, implemented at least part by a computing device, for generating a visual representation of a concept utilizing data available on-line, the method comprising:
receiving a request from a user to access a system;
creating a client session for the user;
sending a concept search page to a web browser associated with the user;
receiving a request from the user for a concept search;
generating an ontology matrix of available information;
transforming data coordinates associated with the ontology matrix into scalable vector graphic coordinates; and
forwarding the transformed data.

6. A method, implemented at least part by a computing device, for performing a simulation utilizing data available on-line, the method comprising:
receiving a request from a user to access a system;
creating a client session for the user,
sending a concept search page to a web browser associated with the user;
receiving a request from the user for a concept search;
generating an ontology matrix of available information;
transforming data into code, which when executed, simulates the dynamic data; and
periodically forwarding results of the simulation.
